(19) United States
(12) Patent Application Publication
(10) Pub. No.: US 2026/0249415 A1
(43) Pub. Date: Aug. 27, 2026

(54) SURFACE TREATMENT MEMBER AND SURFACE TREATMENT SYSTEM

(71) Applicant: JAPAN PRODUCTION & SALES COMPANY LLC, Nagano (JP)

(72) Inventor: Koji YAMAZAKI, Nagano (JP)

(21) Appl. No.: 18/857,816

(22) PCT Filed: Jun. 30, 2022
(86) PCT No.: PCT/JP2022/026891

§ 371 Date: Oct. 18, 2024

(51) Int. Cl. B24B 23/02

(52) U.S. Cl. CPC B24B 23/02

(57) ABSTRACT

Provided with a surface treatment member used by being mounted on a rotary member in a surface treatment system including the rotary member. The surface treatment member includes: a base; and a striking member being rotatably mounted on the base and being configured to impinge on a surface treatment object and to impart an impact to the surface treatment object when using, wherein the base has a stopper that regulates a rotational angle of the striking member. By using the surface treatment member of the present invention to the surface treatment system that includes the rotary member, when the surface preparation is performed, the adhesiveness of a paint can be enhanced and, at the same time, the surface preparation can be performed easily. Further, in the surface treatment member, the base has the stopper and hence, it is possible to make the striking member properly impinge on the surface treatment object by controlling the rotation of the striking member.

### RELATED APPLICATIONS

The present application is a National Phase of International Application No. PCT/JP2022/026891 filed Jun. 30, 2022.

### TECHNICAL FIELD

The present invention relates to a surface treatment member and a surface treatment system.

### BACKGROUND ART

In applying coating or painting to a construction material or the like, it is preferable to apply a surface preparation to a construction material surface before applying coating or painting. The surface preparation is the treatment that is performed for bringing a surface of a coating applying object into a state suitable for coating or painting. When coating is performed without performing the surface preparation, an adhering force of a paint is lowered due to the presence of a foreign material (a rust, an old coated film or the like) thus giving rise to a case where the coating applying object cannot be sufficiently protected. The surface preparation is also referred to as substrate treatment, cleaning or the like.

The surface preparation can be performed, for example, using a grinding tool that includes a disc-type or belt-type grinder (sander) (see patent literature 1, for example). Further, the surface preparation can be also performed using a rotary tool having an annular brush (see patent literature 2, for example). Further, the surface preparation can be also performed by a method that blasts particle-like materials to a treatment object (a blasting method) (see patent literature 3, for example).

### CITATION LIST

### Patent Literature

PTL 1: JP-A-2007-307701

PTL 2: JP-A-2006-212772

PTL 3: JP-A-2005-111628

### SUMMARY OF INVENTION

### Technical Problem

However, when the surface preparation is performed using the conventional grinding tool or a rotary tool, a pattern having a scratch shape is formed on a surface treatment object. Accordingly, compared to the surface preparation performed by a blast method where concaves and convexes having a dot shape are formed on a surface treatment object, there arises a drawback that the adhesiveness of a paint is lowered. On the other hand, the surface preparation by the blast method has a drawback that a large-sized preparation is necessary in advance and a drawback that the surface preparation cannot be performed easily due to a reason that a large amount of waste is generated.

The present invention has been made to overcome the above-mentioned drawbacks, and it is an object of the present invention to provide a surface treatment system capable of increasing adhesiveness of a paint and capable of easily performing surface preparation, and a surface treatment member used in the surface treatment system.

### Solution to Problem

[1] A surface treatment member according to the present invention is a surface treatment member used by being mounted on a rotary member in a surface treatment system including the rotary member. The surface treatment member includes: a base being mountable on the rotary member; and a striking member being rotatably mounted on the base and being configured to impinge on a surface treatment object and to impart an impact to the surface treatment object when using, wherein the base has a stopper that regulates a rotational angle of the striking member.

[2] In the surface treatment member according to the present invention, it is preferable that the striking member have an acute-angled impinging portion.

[3] In the surface treatment member according to the present invention, it is preferable that, as the surface treatment member is viewed along an imaginary axis about which the base is rotated, the stopper restrict a rotational angle of the striking member such that, when the striking member is disposed below the imaginary axis in a gravity direction and an imaginary line that connects the imaginary axis and the rotational axis of the striking member is made parallel to the gravity direction, the impinging portion is positioned behind the imaginary line in the rotational direction.

[4] In the surface treatment member according to the present invention, it is preferable that the surface treatment member include a plurality of striking members, and
the rotational axes of the striking members be disposed on a circumference about an imaginary axis about which the base is rotated.

[5] In the surface treatment member according to the present invention, it is preferable that the stopper be disposed so as to include (overlap with) an imaginary axis, and restrict a rotational angle of the striking member.

[6] In the surface treatment member according to the present invention, it is preferable that, as the surface treatment member is viewed along an imaginary axis, an outer edge of the base have a circular shape about the imaginary axis, and a portion of the striking member be exposed to the outside of an outer edge of the base due to a centrifugal force generated when the surface treatment member is rotated, and an entirety of the striking member is retractable to the inside the outer edge of the base after the striking member impinges on the surface treatment object.

[7] A surface treatment system according to the present invention includes: a rotary member being rotatable by a drive means; and a surface treatment member that is mounted on the rotary member, wherein the surface treatment member includes: a base mounted on the rotary member; and a striking member being rotatably mounted on the base and being configured to impinge on a surface treatment object and to impart an impact to the surface treatment object when using, wherein the base has a stopper that regulates a rotational angle of the striking member.

[8] In the surface treatment system according to the present invention, it is preferable that the surface treatment system further include a guide member that protrudes toward a surface treatment object side from the base when using, a portion of the striking member be exposed to the outside of an outer edge of the guide member due to a centrifugal force generated when the surface treatment member is rotated, and an entirety of the striking member is retractable to the inside the outer edge of the guide member after the striking member impinges on the surface treatment object.

Advantageous effects of Invention In the surface treatment t member according to the present invention, the surface treatment member includes: the base being mountable on the rotary member; and the striking member being rotatably mounted on the base and being configured to impinge on the surface treatment object and to impart an impact to the surface treatment object when using, wherein the base has the stopper that regulates a rotational angle of the striking member. Accordingly, by performing the substrate preparation by the surface treatment system that uses the surface treatment member of the present invention, after the striking member impinges on the surface treatment object, the striking member speedily rotates so as to be separated from the surface treatment object and hence, concaves and convexes having a dot shape are formed on the surface treatment object but not forming a pattern having a scratch shape. As a result, according to the surface treatment member of the present invention, by using the surface treatment member as a portion of the surface treatment system, it is possible to enhance adhesiveness of a paint when the surface preparation is performed. Further, according to the surface treatment member of the present invention, by using the surface treatment member as a portion of the surface treatment system, the surface treatment system can be used in the same feeling as a conventional griding tool or rotating tool and hence, the surface preparation can be performed easily.

The surface treatment system according to the present invention includes the surface treatment member according to the present invention and hence, it is possible to provide the surface treatment system that can enhance the adhesiveness of a paint and enable the easy surface preparation.

### BRIEF DESCRIPTION OF DRAWINGS

FIG. 1A to FIG. 1D are views for illustrating a surface treatment member 1 according to an embodiment 1.

FIG. 2A and FIG. 2B are views of the surface treatment member 1 according to the embodiment 1.

FIG. 3A and FIG. 3B are views illustrating a striking member 40 in the embodiment 1.

FIG. 4A and FIG. 4B are views illustrating a surface treatment system 100 according to the embodiment 1.

FIG. 5A to FIG. 5C are views illustrating the surface treatment system 100 according to the embodiment 1.

FIG. 6A to FIG. 6D are views illustrating the behavior of the striking member 40 in the surface treatment system 100 according to the embodiment 1.

FIG. 7A to FIG. 7D are views illustrating a surface treatment system 2 according to an embodiment 2.

FIG. 8A and FIG. 8B are views illustrating the surface treatment system 2 according to the embodiment 2.

FIG. 9A and FIG. 9B are views illustrating a surface treatment system 200 according to an embodiment 3.

FIG. 10A and FIG. 10B are views illustrating a surface treatment system 200 according to the embodiment 3.

### DESCRIPTION OF EMBODIMENTS

Hereinafter, the description is made with respect to a surface treatment member and a surface treatment system according to the present invention based on respective embodiments with reference to drawings. The respective drawings are schematic views, and do not always strictly reflect actual structures and configurations. The respective embodiments described hereinafter do not limit the present invention called for in claims. Further, it is not always the case where all of various components and the combinations of these components that are described in the respective embodiments are indispensable in the present invention. In the description made hereinafter, there may be a case where, with respect to constitutional elements that are considered substantially identical, the same symbols are used over the embodiments, and repetitious description of these constitutional elements is omitted.

### Embodiment 1

### 1. Surface Treatment Member 1

First, the surface treatment member 1 according to the embodiment 1 is described.

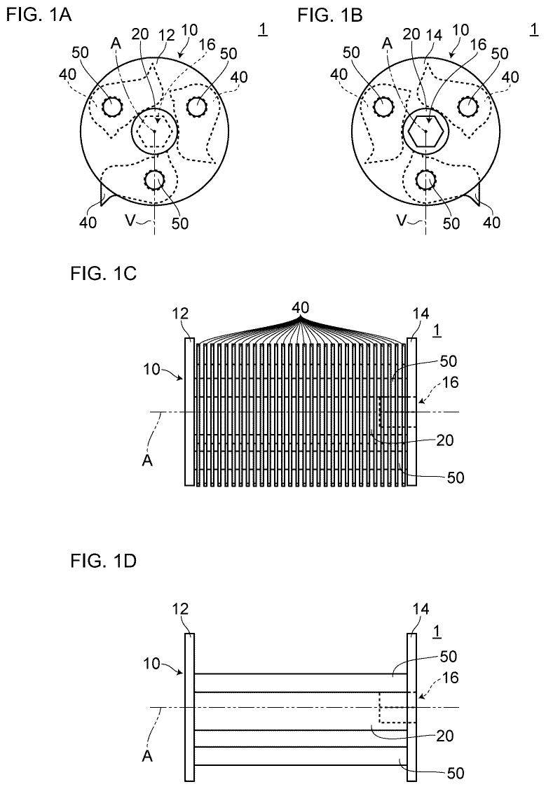

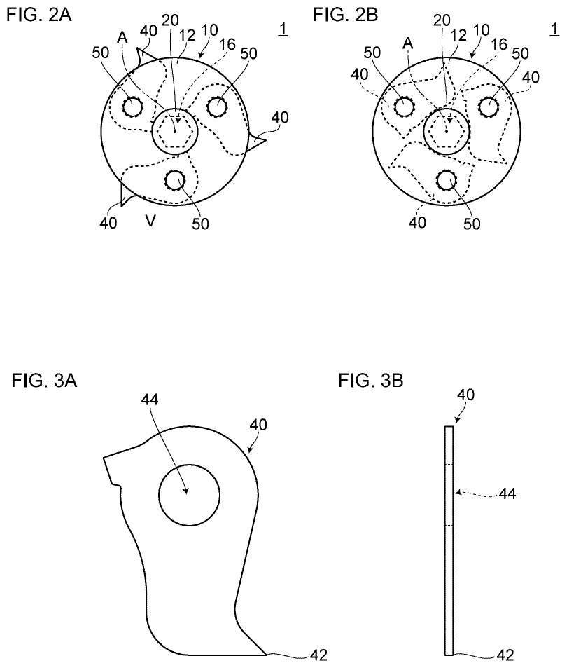

FIG. 1A to FIG. 2B are views illustrating the surface treatment member 1 according to the embodiment 1.

FIG. 1A is a front view of the surface treatment member 1 when the surface treatment member 1 is not used (in a stationary state), FIG. 1B is a rear view of the surface treatment member 1 illustrated in FIG. 1A, FIG. 1C is a right side view of the surface treatment member 1 illustrated in FIG. 1A, and FIG. 1D is a view illustrating the surface treatment member 1 in a state where striking members 40 are removed from the surface treatment member 1 illustrated in FIG. 1C.

FIG. 2A is a front view of the surface treatment member 1 during a use time (during a rotation time), and FIG. 2B is a front view of the surface treatment member 1 in a state where all striking members 40 are retracted to the inside of an outer periphery of a base 10. In FIG. 1A to FIG. 2B, the lower direction in the drawing is the gravity direction. This understanding is substantially equal to the front view and the right side view. Further, in FIG. 1C, the number of striking members 40 illustrated in the drawing is large and hence, only some striking members 40 are indicated by symbols. The same goes for the right side view and the plan view (top plan view) described later.

FIG. 3A and FIG. 3B are views illustrating the striking member 40 according to the embodiment 1. FIG. 3A is a front view of the striking member 40, and FIG. 3B is a right side view of the striking member 40 in FIG. 3A. In FIG. 3A and FIG. 3B, the striking member 40 is illustrated in an enlarged manner compared to FIG. 1A to FIG. 2B.

The surface treatment member 1 is a surface treatment member that is used in a state that the surface treatment member 1 is mounted on a rotary member 110 in the surface treatment system 100 (described later) that includes the rotary member 110. The surface treatment member 1 includes, as illustrated in FIG. 1A to FIG. 2B, the base 10, the striking members 40 and a shaft member 50.

The base 10 is a member that can be mounted on the rotary member 110. The base 10 includes a first circular member 12, a second circular member 14, and a stopper 20. When viewed in FIG. 1A and FIG. 1B, the first circular member 12 and the second circular member 14 each are circular-disk-like members having a circular shape that has its center on an imaginary axis A around which the base 10 is rotated. The stopper 20 is a member that regulates a rotational angle of the striking members 40. Further, the stopper 20 in the embodiment 1 is also a shaft member that is disposed along the imaginary axis A for rotating the base 10, and connects the first circular member 12 and the second circular member 14. The stopper 20 is described again after describing the striking members 40. The base 10 may further include members other than these members (for example, members for fixing or joining the respective members). When the surface treatment member 1 is viewed along the imaginary axis A (as viewed in FIG. 1A or FIG. 1B), an outer periphery of the base 10 forms a circular shape having its center on the imaginary axis A.

In a side of the second circular member 14 of the base 10, a mounting hole 16 that corresponds to a mounting portion 112 (described later) of the rotary member 110 is formed (see FIG. 1B).

The respective members that form the base 10 are constituted using a material that is basically made of metal, a resin or rubber, for example. These members may be formed using a single material, or may be formed using a plurality of materials.

The striking member 40 is a member that is rotatably mounted on the base 10, and impinges on a surface treatment object and imparts an impact to the surface treatment object when using. As illustrated in FIG. 3A and FIG. 3B, the striking member 40 has an acute-angle-shaped impinging portion 42. The impinging portion 42 of the striking member 40 may be also expressed as a portion that impinges on the surface treatment object when the surface treatment system 100 is used in an appropriate mode. The impinging portion 42 is directed in a frontward side in the rotational direction that the surface treatment member 1 is to be rotated. Further, a shaft hole 44 through which the shaft member 50 passes is formed in the striking member 40.

A specific shape, a specific constitutional material, specific physical properties and the like of the striking member 40 can be suitably decided in response to use applications or the like. The striking member 40 according to the embodiment 1 can be manufactured by working a metal plate, for example. Hardness of the impinging portion 42 is preferably 40 or more by Rockwell C scale hardness. The entirety of the striking member 40 preferably falls within range of the above-mentioned hardness. By giving the above-mentioned hardness to the striking member 40, it is possible to form sufficient concaves and convexes also on a surface treatment object made of a steel material.

As the surface treatment member 1 is viewed along the imaginary axis A, when the surface treatment member 1 is rotated, a portion of the striking member 40 (a portion including the impinging portion 42) is exposed to the outside of an outer edge of the base 10 due to a centrifugal force (see FIG. 2A), and after the surface treatment member 1 impinges on the surface treatment object, the entirety of the striking member 40 is retractable to the inside of the outer edge of the base 10 (see FIG. 2B). The retraction of the striking member 40 does not depend on the deformation (bending, elongation or the like) of the base 10 and the striking member 40. This matter is described in detail in a paragraph “behavior of striking member 40 at the time of performing surface preparation using surface treatment system 100”.

As the surface treatment member 1 is viewed along the imaginary axis A about which the base 10 is rotated, the stopper 20 regulates a rotational angle of the striking member 40 as described below. That is, the stopper 20 regulates a rotational angle of the striking member 40 such that, when the striking member 40 is disposed below the imaginary axis A in a gravity direction and an imaginary line V that connects the imaginary axis A and the rotational axis of the striking member 40 (the center of the shaft member 50) is made parallel to the gravity direction (see FIG. 1A and FIG. 1B), the impinging portion 42 is positioned behind the imaginary line V in the rotational direction.

The surface treatment member 1 includes a plurality of striking members 40. The rotational axis of the striking member 40 (the center of the shaft member 50) is disposed on the circumference about the imaginary axis A about which the base 10 is rotated. The stopper 20 is disposed so as to include (overlap with) an imaginary axis A, and regulates the rotational angle of the plurality of (all in the embodiment 1) striking members 40.

In the embodiment 1, 30 pieces of striking members 40 are mounted along the direction that the imaginary axis A extends (see FIG. 1C). Further, these constitutional elements form one set, and the surface treatment member 1 includes three sets of these striking members 40. Such a configuration is provided for an exemplifying purpose, and the number of striking members 40 in a row or the number of sets of striking members 40 may be suitably set corresponding to a kind of a surface treatment object or the like. The striking members 40 are respectively independently mounted. By arranging the striking members 40 in this manner, even in a case where concaves and convexes or curved surfaces are formed on a surface treatment object, it is possible to perform the surface preparation smoothly.

The shaft members 50 are rod-shaped members that are disposed so as to pass through shaft holes 44 formed in the respective striking members 40, and are fixed to the base 10. The shaft member 50 may be also referred to as a member that mounts the striking member 40 on the base 10.

### 2. Surface Treatment System 100

Next, the surface treatment system 100 according to the embodiment 1 is described.

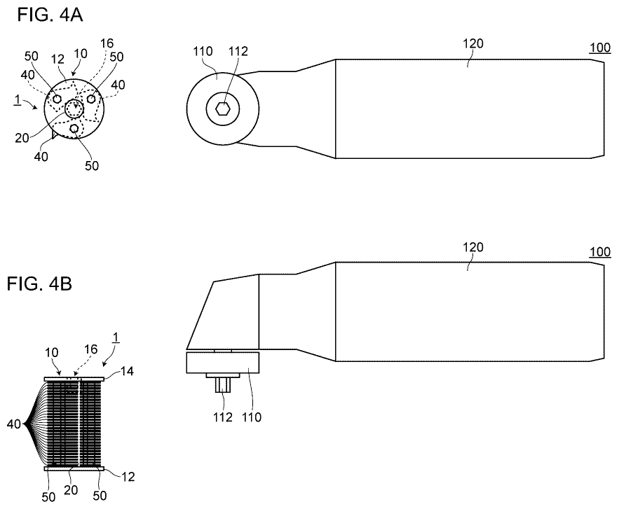

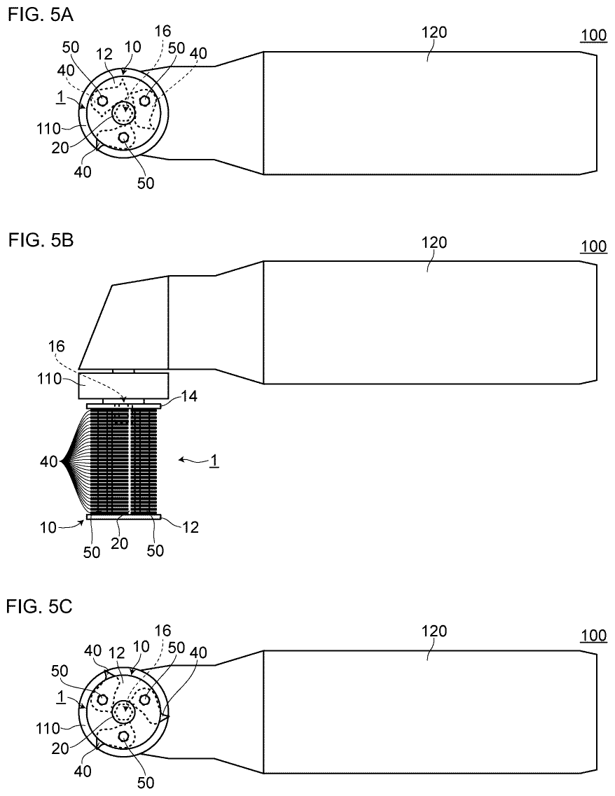

FIG. 4A to FIG. 5C are views for describing the surface treatment system 100 according to the embodiment 1. It may be safe to say that FIG. 4A and FIG. 4B are views illustrating a state where the surface treatment member 1 is removed from the rotary member 110, and FIG. 4A is a front view, FIG. 4B is a plan view (top plan view). It is also safe to say that FIG. 5A to FIG. 5C are views illustrating a state where the surface treatment member 1 is mounted on the rotary member 110. FIG. 5A is a front view illustrating a state where the surface treatment member 1 is disposed in a stationary state, FIG. 5B is a plan view (top plan view) of the surface treatment member 1 illustrated in FIG. 5A, and FIG. 5C is a front view of the surface treatment member 1 illustrating a state where the surface treatment member 1 is rotated.

As illustrated in FIG. 4A to FIG. 5C, the surface treatment system 100 according to the embodiment 1 includes the surface treatment member 1, the rotary member 110, and a grip portion 120. The surface treatment system 100 may be also referred to as a handy power tool surface treatment system 100 (rotary tool). The surface treatment system 100 includes other constitutional elements for rotational driving besides the above-mentioned constitutional elements. However, these other constitutional elements are known constitutional elements and hence, the description and the illustration of these constitutional elements are omitted. Further, the surface treatment system 100 may include constitutional elements that are not indispensable (for example, a cover that prevents scattering of dust and an auxiliary grip) besides the above-mentioned constitutional elements.

In this specification, “surface treatment system” means a combination of a device and members that can be used in performing the surface treatment. In this embodiment, the surface treatment system is not limited to a handy power tool such as the surface treatment system 100, and may include a robot, a drone or the like that can be operated by a remote control operation or an automatic control operation, for example. The usage of the surface treatment system according to the present invention is not limited to the surface preparation of an object to be coated. The surface treatment system according to the present invention can be also used for enhancing the surface treatment of a joining surface or the surface treatment for enhancing aesthetic appearance.

The surface treatment member 1 is mounted on the rotary member 110. In the surface treatment system 100, a mounting portion 112 (see FIG. 4A and FIG. 4B) of the rotary member 110 is inserted into a mounting hole 16 of the surface treatment member 1 (base 10). In the embodiment 1, a case is exemplified where the mounting portion 112 has a hexagonal columnar shape, and the mounting hole 16 has a hexagonal columnar shape. The shape of the mounting portion and the shape of the mounting hole are not specifically limited provided that a rotational force of the rotary member can be transmitted to the surface treatment member. Further, the mounting portion and the mounting hole may have a structure or a mechanism (for example, a concave-convex shape, a locking mechanism or the like) for preventing an unintended removal of the surface treatment member 1. Further, if the surface treatment member can be mounted on the rotary member, such a structure or a mechanism is not limited to a combination of the mounting portion and the mounting hole.

The rotary member 110 is a member that can be rotated by a drive means (not illustrated in the drawings). The rotary member 110 includes the mounting portion 112 having a shape corresponding to the mounting hole 16. To rotate the surface treatment member 1, the rotary member 110 is connected to the drive means that generates a rotating force generated by a suitable means (for example, gears, a belt, a shaft or the like). Although a type of the drive unit is not particularly limited, as an example, an electrically operated motor, a pressure motor (for example, a pneumatic pressure motor, a water pressure motor or 2 hydraulic pressure motor) or an internal combustion engine can be named.

The grip portion 120 is a portion that a user grips when the user uses the surface treatment system 100. The grip portion 120 may incorporate various mechanisms (for example, the entirety or a portion of the drive means, a transmission, a transformer and the like).

### 3. Behavior of Striking Members 40 in Performing Surface Preparation by Surface Treatment System 100

Next, the behavior of the striking members 40 in performing surface preparation (at the time of actual use) is described.

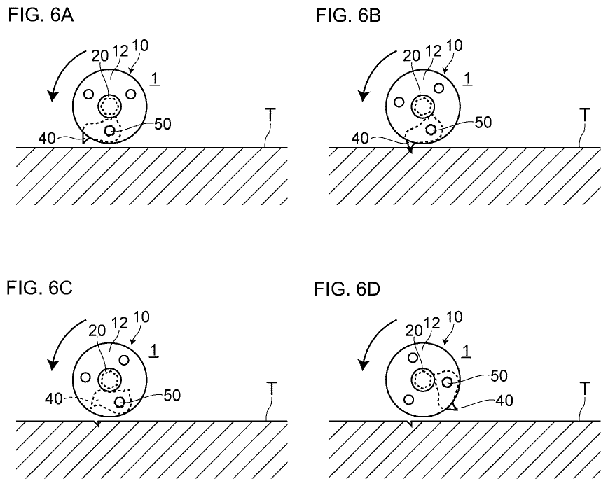

FIG. 6A to FIG. 6D are views for describing the behavior of the striking member 40 in the surface treatment system 100 according to the embodiment 1. FIG. 6A to FIG. 6D are views illustrating the movement of the surface treatment member 1 and the movement of the striking member 40 with the lapse of time. In FIG. 6A to FIG. 6D, to facilitate the understanding Of the drawing, only one striking member 40 is illustrated with respect to the striking members 40, and the constitutional elements of the surface treatment system 100 other than the surface treatment member 1 are not illustrated in the drawing. In FIG. 6A to FIG. 6D, an arrow indicated on a left side of the surface treatment member 1 in the drawing indicates a rotational direction of the surface treatment member 1. In FIG. 6A to FIG. 6D, the illustration of a foreign substance (an old coated film, a rust or the like) that may exist by a chance on a surface treatment object T is omitted.

With respect to the striking member 40 that is mounted on the base 10 that is rotated together with the rotary member 110 by way of the shaft member 50, when the surface treatment member 1 is rotated, a portion of the striking member 40 is exposed outside from the outer periphery of the base 10 (see FIG. 6A) due to a centrifugal force. Due to the rotation Of the base 10, the striking member 40 approaches and impinges on the surface treatment object T (see FIG. 6B). At this stage of the operation, a dot-shaped recess is formed on the surface treatment object T by the impinging portions 42 of the striking member 40. After impinging on the surface treatment object T, the striking member 40 is rotated such that the striking member 40 bounces up due to reaction of impingement, and the entirety of the striking member 40 is retractable toward the inside the outer periphery of the base 10 (see FIG. 6C). In a state where the striking member 40 is retracted toward the inside the outer periphery of the base 10, the striking member 40 passes an area where the base 10 and the surface treatment object T approach closest to each other. Then, a portion of the striking member 40 is again exposed outside from the outer periphery of the base 10 due to a centrifugal force (see FIG. 6D).

There is a possibility that the striking member 40 is brought into contact with the surface treatment object T at a point of time that the striking member 40 passes the area where the base 10 and the surface treatment object T approach closest to each other. However, the striking member 40 has almost no energy at this point of time and hence, substantially no pattern having a scratch shape is formed on the surface treatment object T.

A rotational angle of the striking member 40 is regulated by the stopper 20 (see FIG. 6A, FIG. 6B). Particularly, in the embodiment 1, the stopper 20 regulates a rotational angle of the striking member 40 such that, when the striking member 40 is disposed below the imaginary axis A in a gravity direction and an imaginary line V that connects the imaginary axis A and the rotational axis of the striking member 40 (the center of the shaft member 50) is made parallel to the gravity direction, the impinging portion 42 is positioned behind the imaginary line V in the rotational direction. Accordingly, when the impinging portion 42 of the striking member 40 impinges on the surface treatment object T, the impinging portion 42 impinges on the surface treatment object T at the position spaced apart from between the rotational axis of the striking member 40 and the surface treatment object (see FIG. 6B). As a result, the striking member 40 smoothly rotates after impinging on the surface treatment object T.

### 4. Advantageous Effects

Hereinafter, the advantageous effects acquired by the surface treatment member 1 and the surface treatment system 100 according to the embodiment 1 are described.

The surface treatment member 1 according to the embodiment 1 includes: the base 10 that can be mounted on the rotary member 110; and the striking members 40 each are rotatably mounted on the base 10 and impinge on the surface treatment object and impart impact to the surface treatment object when using, wherein the base 10 has the stopper 20 that regulates a rotational angle of the striking members 40. With such a configuration, by performing the surface preparation using the surface treatment system 100 that includes the surface treatment member 1 according to the present invention, the striking members 40 speedily rotate and, particularly, the impinging portions 42 are separated from the surface treatment object after impinging on the surface treatment object. Accordingly, concaves and convexes having a dot shape are formed on the surface treatment object but not forming patterns having a scratch shape. As a result, according to the surface treatment member 1 of the embodiment 1, by using the surface treatment member 1 as a part of the surface treatment system 100, it is possible to increase adhesiveness of a paint when the surface preparation is performed. Further, according to the surface treatment member 1 of the embodiment 1, by using the surface treatment member 1 as a part of the surface treatment system 100, the surface treatment system 100 can be used with substantially the same feeling that a user has when using a conventional grinding tool or a conventional rotary tool and hence, the surface preparation can be performed easily.

Further, according to the surface treatment member 1 of the embodiment 1, the striking members 40 are rotatably mounted on the base 10 and hence, compared to a surface treatment member where the movement of a striking member depends on the deformation of a base or the striking member (for example, an annular brush described in patent literature 2), a repulsive force that is generated when the surface preparation is performed can be reduced and hence, it is possible to reduce a force necessary for holding the surface treatment system 100 at an appropriate position.

Further, according to the surface treatment member 1 of the embodiment 1, the base 10 has the stopper 20 that regulates a rotational angle of the striking members 40. Accordingly, it is possible to make the striking members properly impinge on the surface treatment object by controlling the rotation of the striking members 40.

Further, according to the surface treatment member 1 of the embodiment 1, the striking member 40 has the acute-angled impinging portion 42 and hence, it is possible to form a fine deep recessed portion on the surface treatment object.

Further, according to the surface treatment member 1 of the embodiment 1, when viewed along the imaginary axis A about which the base 10 is rotated, the stopper 20 regulates a rotational angle of the striking member 40 such that, when the striking member 40 is disposed below the imaginary axis A in a gravity direction and the imaginary line V that connects the imaginary axis A and the rotational axis of the striking member 40 is made parallel to the gravity direction, the impinging portion 42 is positioned behind the imaginary line V in the rotational direction. With such a configuration, it is possible to make the impinging portion 42 impinge on the surface treatment object T at the position spaced apart from between the rotational axis of the striking member 40 and the surface treatment object. Accordingly, the striking member 40 can be smoothly rotated after the impinging member 42 impinges on the surface treatment object T. As a result, it is possible to suppress an excessively large load from being applied to the striking member 40 and other members when the impinging member 42 impinges on the surface treatment object.

Further, according to the surface treatment member 1 of the embodiment 1, the surface treatment member 1 includes the plurality of striking members 40 and, at the same time, the rotary axes of the striking members 40 are disposed on a circumference about the imaginary axis A about which the base 10 is rotated. Accordingly, loads (impacts) that the respective striking members 40 receive when the impinging portions 42 impinge on the surface treatment members can be set substantially equal.

Further, according to the surface treatment member 1 of the embodiment 1, the stopper 20 is disposed so as to include (overlap with) the imaginary axis A and, at the same time, the stopper 20 regulates the rotational angles of the plurality of striking members 40. Accordingly, compared to a case where a stopper is provided to each of respective striking members 40 disposed on the circumference about the imaginary axis A (see an embodiment 2), the surface treatment member 1 according to the embodiment 1 can have a compact structure by reducing the number of members. As an advantageous effect of the compact structure, it is possible to name an advantageous effect that the surface preparation can be applied to a metal member that forms a narrow portion (for example, a joint disposed on a seam of a road).

Further, according to the surface treatment member 1 of the embodiment 1, when the surface treatment member 1 is viewed along the imaginary axis A, an outer edge of the base 10 is formed in a circular shape about the imaginary axis A, and a portion of the striking member 40 can be exposed to the outside of an outer edge of the base 10 due to a centrifugal force generated when the surface treatment member 1 is rotated, and the entirety of the striking member 40 is retractable to the inside of the outer edge of the base 10 after the striking member 40 impinges on the surface treatment object. Accordingly, in performing the surface preparation, even in a case where the surface treatment object and the base 10 of the surface treatment member 1 approach to each other to an extent that the surface treatment object and the base 10 of the surface treatment member 1 are about to be brought into contact with each other or are brought into contact with each other, the formation of a pattern having a scratch shape can be suppressed, and a breakage of the member that constitutes the surface treatment member 1 can be suppressed.

The surface treatment system 100 according to the embodiment 1 includes the surface treatment member 1 according to the embodiment 1 and hence, it is possible to provide the surface treatment system where the adhesiveness of a paint can be increased, and surface preparation can be performed easily.

### Embodiment 2

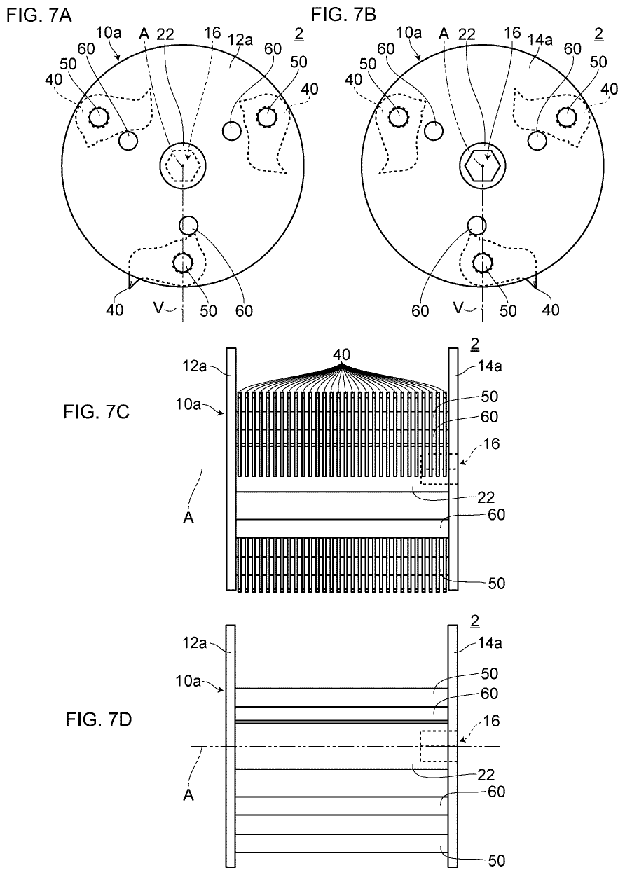

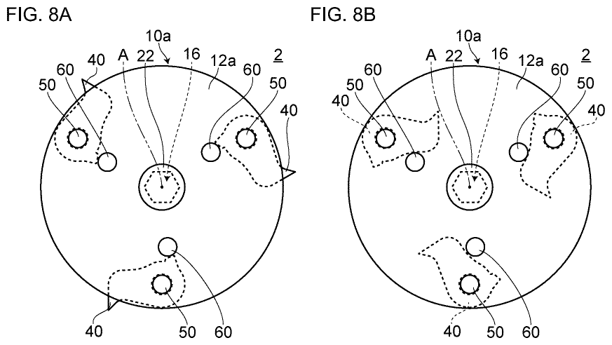

FIG. 7A to FIG. 8B are views illustrating the surface treatment member 2 according to the embodiment 2. FIG. 7A is a front view of the surface treatment member 2 when the surface treatment member 2 is not used (in a stationary state), FIG. 7B is a rear view of the surface treatment member 2 illustrated in FIG. 7A, FIG. 7C is a right side view of the surface treatment member 2 illustrated in FIG. 7A, and FIG. 7D is a view illustrating the surface treatment member 2 in a state where striking members 40 are removed (not illustrated) from the surface treatment member 2 illustrated in FIG. 7C. FIG. 8A is a front view of the surface treatment member 1 during a use time (during a rotation time), and FIG. 8B is a front view of the surface treatment member 2 in a state where all striking members 40 are retracted to the inside of an outer periphery of a base 10a.

The surface treatment member 2 according to the embodiment 2 has basically substantially the same configuration as the surface treatment member 1 according to the embodiment 1. However, the surface treatment member 2 according to the embodiment 2 differs from the surface treatment member 1 according to the embodiment 1 with respect to the configuration of the base. As illustrated in FIG. 7A to FIG. 8B, the base 10a of the surface treatment member 2 has a first circular member 12a, a second circular member 14a, a shaft member 22 and stoppers 60. The constitutional elements of the surface treatment member 2 other than the base 10a are substantially equal to the corresponding constitutional elements of the surface treatment member 1 of the embodiment 1 and hence, the repeated description is omitted.

When viewed along an imaginary axis A about which the base 10a is rotated, these members are formed in circular shapes having larger diameters than the first circular member 12a and the second circular member 14a in the embodiment 1 (see FIG. 7A and FIG. 7B). The shaft member 22 has substantially the same configuration as the stopper 20 in the embodiment 1, the base 10a has stoppers 60 in addition to the shaft member 22 and hence, the shaft member 22 does not function as a stopper for regulating a rotational angle of the striking member 40.

The base 10a has three stoppers 60. The stoppers 60 are provided for regulating rotational angles of one set of the striking members 40 mounted on the base 10a in a state where the striking members 40 extend in parallel in a direction along the imaginary axis A, for each stopper 60 (see FIG. 8A).

Although the surface treatment member 2 according to the embodiment 2 differs from the surface treatment member 1 according to the embodiment 1 with respect to the configuration of the base, the surface treatment member 2 according to the embodiment 2 includes the base 10a that can be mounted on a rotary member, and the striking member 40 that is rotatably mounted on the base 10a and impinges on the surface treatment object and imparts an impact to the surface treatment object when using, and the base 10a includes the stoppers 60 that regulate the rotational angles of the striking members 40. Accordingly, by using the surface treatment member 2 in the surface treatment system that includes a rotary member, in the same manner as the surface treatment member 1 according to the embodiment 1, it is possible to increase adhesiveness of a paint when the surface preparation is performed and, at the same time, it is possible to provide a surface treatment member to which the surface preparation can be easily applied.

Further, according to the surface treatment member 2 of the embodiment 2, the base 10a has a plurality of stoppers 60 and hence, compared to the case where only one stopper 60 is used, a load applied to one stopper 60 can be reduced.

Further, according to the surface treatment member 2 of the embodiment 2, the shaft member 22 and the stoppers 60 are separate bodies from each other and hence, the degree of freedom in the configuration of the surface treatment member 2 can be increased.

The surface treatment member 2 according to the embodiment 2 has the corresponding advantageous effects amongst the advantageous effects that the surface treatment member 1 according to the embodiment 1 has.

### Embodiment 3

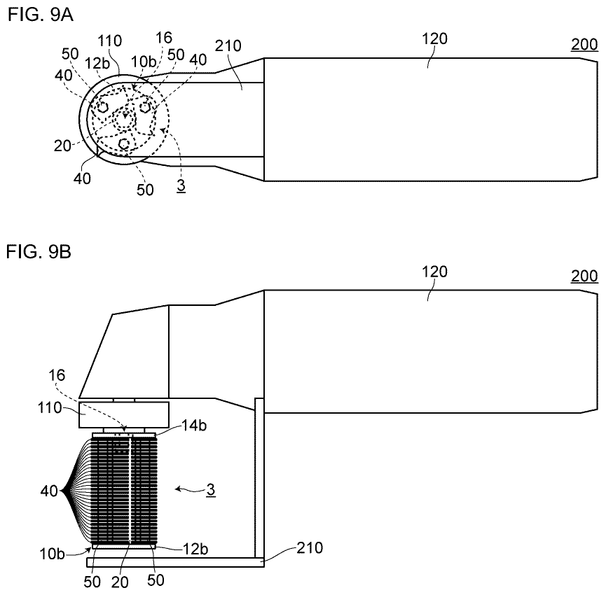

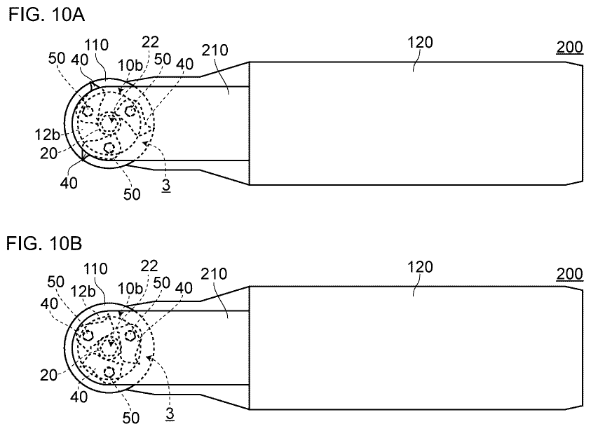

FIG. 9A to FIG. 10B are views illustrating a surface treatment system 200 according to an embodiment 3. FIG. 9A is a front view of a surface treatment member 3 when the surface treatment member 3 is in a stationary state, FIG. 9B is a plan view (a top plan view) of the surface treatment system 200 illustrated in FIG. 9B. FIG. 10A is a front view of the surface treatment member 3 in a state where the surface treatment member 3 is rotating, and FIG. 10B is a front view of the surface treatment member 3 in a state where all striking members 40 are retracted to the inside of an outer edge of a guide member 210.

The surface treatment system 200 according to the embodiment 3 has basically substantially the same configuration as the surface treatment system 100 according to the embodiment 1. However, the surface treatment system 200 according to the embodiment 3 differs from the surface treatment system 100 according to the embodiment 1 with respect to a point that the configuration of a surface treatment member is different and the surface treatment system 200 according to the embodiment 3 further includes a guide member. The surface treatment system 200 according to the embodiment 3, as illustrated in FIG. 9A to FIG. 10B, includes the surface treatment member 3, a rotary member 110, a grip portion 120 and a guide member 210. Among such constitutional elements, the rotary member 110 and the grip portion 120 have substantially the same configuration as corresponding members in the surface treatment system 100 according to the embodiment 1.

Hereinafter, the surface treatment system 200 according to the embodiment 3 is described by mainly focusing on points that make the surface treatment system 200 differ from the surface treatment system 100 of the embodiment 1.

The surface treatment member 3 is mounted on the rotary member 110. The surface treatment member 3 includes: a base 10b that is mounted on the rotary member; striking members 40, and a shaft member 50. Among these members, the striking members 40 and the shaft member 50 are substantially the same as the striking members 40 and the shaft member 50 in the embodiment 1.

The base 10b includes a first circular member 12b, a second circular member 14b, and a stopper 20 (see FIG. 9A and FIG. 9B. Among these members, when viewed along a rotational axis of the rotary member 110, although an outer edge of the base 10b has a circular shape about the rotational axis, a diameter of the outer edge is set smaller than a dimeter of the base 10 in the embodiment 1. Accordingly, when viewed by taking into account only the surface treatment member 3, after the striking member 40 impinges on the surface treatment object, the entirety of the striking member 40 cannot be retracted to the inside of an outer edge of the base 10b (see FIG. 10B).

The guide member 210 is a member that protrudes more toward a surface treatment object side than the base 10a when using. From a viewpoint of mounting on or removing the surface treatment member 3, it is preferable that the guide member 210 be detachable.

In the surface treatment system 200, when viewed along a rotational axis of the rotary member 110, a portion of the striking members 40 is exposed to the outside of the outer edge of the guide member 210 due to a centrifugal force generated when the surface treatment member rotates (see FIG. 10A), and after the striking member 40 impinges on a surface treatment object, the entirety of each striking member 40 is retractable to the inside of the outer edge of the guide member 210 (see FIG. 10B).

The surface treatment system 200 according to the embodiment 3 differs from surface treatment member 100 according to the embodiment 1 with respect to the point that the configuration of the surface treatment member differs from the configuration of the surface treatment member of the embodiment 1, and the point that the surface treatment system 200 further includes the guide member. However, the surface treatment member 3 includes the base 10b that is mounted on the rotary member 110, and the striking members 40 that are rotatably mounted on the base 10b and impinges on the surface treatment object and imparts an impact to a surface treatment object when using, and the base 10b includes the stopper 20 that regulates the rotational angles of the striking members 40. Accordingly, in the same manner as the surface treatment system 100 according to the embodiment 1, it is possible to increase adhesiveness of a paint and, at the same time, it is possible to provide a surface treatment system to which the surface preparation can be easily applied.

Further, according to the surface treatment system 200 according to the embodiment 3, the surface treatment system 200 further includes the guide member 210 that further protrudes toward a surface treatment object side than the base 10b when using. Accordingly, as viewed along the rotational axis of the rotary member 110, when the surface treatment member rotates, a portion of the striking member 40 is exposed to the outside of the outer edge of the guide member 210 due to a centrifugal force and, at the same time, the entirety of each striking member 40 is retracted to the inside of the outer edge of the guide member 210 after impinging on the surface treatment object. Accordingly, even in a case where the entirety of each striking member 40 cannot be retracted to the inside of the outer edge of the base 10b when viewed by taking into account only the surface treatment member 3, the guide member 210 is brought into contact with the surface treatment object and hence, the formation of a pattern having a scratch shape can be suppressed, and a breakage of the member that constitutes the surface treatment member 3 can be suppressed.

Although the present invention has been described with reference to the respective embodiments described above, the present invention is not limited to the respective embodiments described above. Various modifications can be conceivable without departing from the gist of the present invention, and the following modifications are conceivable, for example.

(1) The shapes, the numbers, the positions and the like of the constitutional elements described in the above-mentioned respective embodiments are provided for an exemplifying purpose, and can be modified within a scope that advantageous effects of the present invention are not jeopardized.

(2) The surface treatment member of the present invention may further include the position adjustment members (spacers or the like) for stopping the contacting between the striking members disposed adjacently.

(3) In the surface treatment member according to the present invention, the striking member includes a shaft for rotation, and a shaft hole through which the shaft passes may be formed in the base.

### INDUSTRIAL APPLICABILITY

The surface treatment members and the surface treatment systems according to the present invention can be suitably used in various applications relating to the surface treatment.

1. A surface treatment member used by being mounted on a rotary member in a surface treatment system including the rotary member, the surface treatment member comprising:
a base being mountable on the rotary member; and
a striking member being rotatably mounted on the base and being configured to impinge on a surface treatment object and to impart an impact to the surface treatment object when using, wherein
the base has a stopper that regulates a rotational angle of the striking member.

2. The surface treatment member according to claim 1, wherein, the striking member has an acute-angled impinging portion.

3. The surface treatment member according to claim 2, wherein, as the surface treatment member is viewed along an imaginary axis about which the base is rotated,
the stopper regulates a rotational angle of the striking member such that, when the striking member is disposed below the imaginary axis in a gravity direction and an imaginary line that connects the imaginary axis and the rotational axis of the striking member is made parallel to the gravity direction, the impinging portion is positioned behind the imaginary line in the rotational direction.

4. The surface treatment member according to any one of claim 3, wherein the surface treatment member includes a plurality of striking members, and
the rotational axes of the striking members are disposed on a circumference about an imaginary axis about which the base is rotated.

5. The surface treatment member according to claim 4, wherein the stopper is disposed so as to include an imaginary axis, and restricts a rotational angle of the plurality of striking members.

6. The surface treatment member according to claim 5, wherein, as the surface treatment member is viewed along an imaginary axis,
an outer edge of the base has a circular shape about the imaginary axis, and
a portion of the striking member is exposed to the outside of an outer edge of the base due to a centrifugal force generated when the surface treatment member is rotated, and an entirety of the striking member is retractable to the inside the outer edge of the base after the striking member impinges on the surface treatment object.

7. A surface treatment system comprising:
a rotary member being rotatable by a drive means; and a surface treatment member that is mounted on the rotary member, wherein
the surface treatment member includes:
a base being mountable on the rotary member; and
a striking member being rotatably mounted on the base and being configured to impinge on a surface treatment object and to impart an impact to the surface treatment object when using, wherein
the base has a stopper that regulates a rotational angle of the striking member.

8. The surface treatment system according to claim 7, wherein
the surface treatment system further includes a guide member that protrudes toward a surface treatment object side from the base when using, and
as viewed along a rotational axis of the rotary member, a portion of the striking member is exposed to the outside of an outer edge of the guide member due to a centrifugal force generated when the surface treatment member is rotated and, an entirety of the striking member is retractable to the inside the outer edge of the guide member after the striking member impinges on the surface treatment object.

9. The surface treatment member according to claim 4, wherein, as the surface treatment member is viewed along an imaginary axis,
an outer edge of the base has a circular shape about the imaginary axis, and
a portion of the striking member is exposed to the outside of an outer edge of the base due to a centrifugal force generated when the surface treatment member is rotated, and an entirety of the striking member is retractable to the inside the outer edge of the base after the striking member impinges on the surface treatment object.
